(19) United States
(12) Patent Application Publication
(10) Pub. No.: US 2012/0310906 A1
(43) Pub. Date: Dec. 6, 2012

(54) Building Information Tracking System and Method of Use

(76) Inventors: Dwayne Miller, Las Vegas, NV (US); Kenneth H. Gardner, Las Vegas, NV (US); Stephen J. Germano, Las Vegas, NV (US); James Chun, Las Vegas, NV (US); Daniel J. Ives, Las Vegas, NV (US)

(21) Appl. No.: 13/488,153

(22) Filed: Jun. 4, 2012

Related U.S. Application Data
(60) Provisional application No. 61/492,902, filed on Jun. 3, 2011.

(51) Int. Cl. G06F 17/30

(52) U.S. Cl. 707/695; 707/E17.044

(57) ABSTRACT

Systems and methods are disclosed for tracking the content of building information models. Embodiments include various computer-implemented methods for the tagging of BIM information, and for the monitoring of modification events involving BIM information. In addition, activities involving physical elements associated with BIM information are tracked. Providers of BIM content can tag content prior to distribution, enabling an internet-based service to track usage, enabling improved service to consumers of that BIM content. Designers can tag BIM content and BIM elements for tracking during the useful life of a building. Internet based messaging protocols can be used for communication between web services, client services and client applications. Monitoring and communication services function unattended. The system includes integration with BIM design applications, as well as stand-alone, end user system applications and browser interfaces. Analytic tools can be used to report on the tracking data.

### CROSS-REFERENCE TO RELATED APPLICATIONS

The present application claims priority through the applicant's prior provisional patent application, entitled Method and System for Identifying, Protecting, and Tracking the Use, Modification, and Versioning of Content for Building Information Modeling, Ser. No. 61/492,902, filed Jun. 3, 2011, which provisional application is hereby incorporated by reference in its entirety.

### FIELD OF TECHNOLOGY

The present invention relates to computer-aided design and drafting (CADD) of buildings and other construction projects and more particularly to advanced methods of Building Information Modeling (BIM).

### BACKGROUND

Building Information Modeling (BIM) is an evolution of architectural computer-aided design and drafting. It is a digital representation of physical and functional characteristics of a facility. BIM is a shared knowledge resource for information about a facility forming a reliable basis for decisions during the building's life-cycle; defined as existing from earliest conception to demolition. BIM represents each element of a building as an intelligent object—a software entity that contains relevant information about the geometry, connectivity, location, performance parameters, etc., of that element. For example, a furnace object may represent: the shape and size of the furnace; how it connects to ductwork, gas supply, and electrical wiring; thermal output capacity; efficiency; location; etc. Such an object, representing a class of building elements, may be referred to as BIM content. An instance of BIM content in a model may be referred to as BIM element.

BIM software facilitates the creation of a three-dimensional, dynamic building model that maintains all of the objects and elements representing the building in their proper relationships. This enables physical views of the building from multiple perspectives. Such a building model comprises building geometry, spatial relationships, geographic information, pertinent physical characteristics, and various quantities and properties of all building elements. The building model may also enable simulation of power consumption, thermal distribution, airflow, lighting, and other building performance requirements.

In general, any user of a BIM Design Application may create or use BIM content to represent a building element. Often it is the case that BIM content is provided by manufacturers for their own building element products to encourage adoption and use of their products by designers. One disadvantage of current BIM Design Applications is that manufacturers may have little or no control over BIM content after it is delivered to a BIM Design Application user. The user of a BIM design application may edit the BIM content, resulting in a suboptimal representation of the associated building element in the building model. The delay in detection can result in costly problems for the user, the manufacturer, the building owner, service personnel, and anyone else who may depend on correct modeling of the particular building element.

A further disadvantage is that manufacturers may have no visibility into when and how their products are being used. They may lack visibility into what specific models and configurations are used, how many instances of their BIM content are in use, which companies are using what BIM content, and in what types of projects specific BIM content is instantiated. This lack of visibility can negatively impact sales, marketing, engineering, and support activities, consequently increasing the cost of delivery and total cost of ownership. Building models created by BIM Design Applications typically contain this kind of information, but this information is typically accessible only by the explicit query of an individual building model by a BIM Design Application user, and only for the single building model currently active in a BIM Design Application instance. As a result, it is difficult for manufacturers to accurately assess the use of their products across an entire user base.

Current methods of attempting to associate a deployed physical building element with correct installation and maintenance information often involve labor-intensive and potentially dangerous manual inspection, and uncertain research into old document archives. Ascertaining the deployed physical building element specification is necessary to pairing such a deployed physical building element with the appropriate corresponding documentation. In the case of performing maintenance on a deployed physical element with limited change history data, the service technician will first need to obtain such data in order to ensure they procure the appropriate documentation and that such documentation is not rendered useless due to the nature of the changes. Inspecting hard-to-access building elements can be both challenging and dangerous, increasing the total cost of ownership. The cost-effectiveness of engaging in many building element activities depends, at least in part, on the acquisition and association of accurate information. Examples of activities where such documentation is needed or desired include as installation, maintenance, warranty, repair, and replacement.

Accordingly, there is a long-felt need for the tagging, tracking and analysis of BIM content and BIM elements, and for recording the events and activities of deployed physical building elements associated therewith.

### BRIEF SUMMARY OF SOME ASPECTS OF THE DISCLOSURE

In some embodiments, a cloud-based tracking service provides a repository and a set of services for recording, tracking and reporting on events and activities associated with tagged BIM content and BIM elements. In various of these embodiments, one or more of the following advantages are realized. BIM content and BIM elements can be tracked across multiple users, models and locations. Diverse applications can access the same repository, expanding the scope of what can be tracked, and therefore improving the quality of the accumulated tracking data and analysis of such data.

In some embodiments, BIM content can be tagged prior to distribution. In various of these embodiments, one or more of the following advantages are realized. BIM content developers can better assist the consumers in optimally using this content. Manufacturers can dynamically address newly-discovered limitations and issues with their products, develop changed content and proactively notify consumers of such content change and the issues requiring these changes.

In some embodiments, BIM content and BIM elements derived from tagged BIM content are automatically tagged at the time they are instantiated. In various of these embodiments, one or more of the following advantages are realized. Content can be tracked without requiring user interaction or involvement. Removal of user-dependent tracking methods results in a robust and complete set of tracking data, allowing the user to safely rely on the tracking systems services, as well as enabling the content provider to generate more accurate analytics based on this tracking data.

In some embodiments, untagged BIM elements can be tagged after instantiation in a BIM model by the user of a BIM Design Application. In various of these embodiments, one or more of the following advantages are realized. The user community is able to realize the benefits of tracking BIM elements even when they are not using tagged BIM content from content providers. For example, a designer can choose to tag all of the BIM elements representing all or part of a building model without regard to whether the BIM elements are derived from manufacturer-provided BIM content. As a result, comprehensive tracking can occur, further reducing the total cost of ownership of constructing and maintaining a building over the useful life of that building.

In some embodiments, modification events to tagged BIM content items and BIM elements are tracked. In various of these embodiments, one or more of the following advantages are realized. The recording and tracking of such events results in improved accuracy in the identification, sourcing and delivery of documentation relating to a deployed physical element. For example, changes to BIM content or BIM element parameters can impact the applicability of documentation. The tracking of the occurrence of such events provides an indication that documentation may need to be assessed for applicability.

In some embodiments, an historical record of metadata associated with modification events to tagged BIM elements is maintained. In various of these embodiments, one or more of the following advantages are realized. A granular and specific assessment of modification events and the applicability of documentation can be obtained based on this historical record. In addition, the maintaining of such an historical record allows manufactures the ability to gain analytical insight into the use of their products across time, users and deployments. For example, they can assess the frequency, type of use, and type of modifications of a product to determine if that product is adequately addressing the needs of the building community. This allows for the manufacturer to plan for both the maintenance life cycle of existing products already deployed, as well as develop a more targeted and focused product plan for future rollouts.

Identification of designs and deployments that include design defects allows manufacturers to play a proactive role in helping designers and service technicians reduce costs associated with addressing defective or problematic designs by identifying such problems earlier in the building life cycle. This earlier detection can result in the elimination of costly cumulative downstream issues. For example, designers can be notified of sub-optimal representations of BIM elements by manufactures at the time the representation is introduced into a model. This allows the stakeholders involved in the building project to determine the costs and benefits associated with the proposed representation, and whether it is prudent to immediately address the defect or defer taking action until a later point in the building life cycle.

In some embodiments, activities involving a physically deployed building element are recorded, tracked and associated with their corresponding BIM element. In various of these embodiments, one or more of the following advantages are realized. Recording and tracking capabilities can reduce the effort required to deliver product and service offerings related to the deployed building element. For example, the recording and tracking of installation and replacement activities enables manufacturers to more quickly respond to warranty-based inquiries from service technicians and building owners. Another advantage of maintaining and tracking the historical record of deployed physical elements through the building life cycle is a reduction is risk with respect to the danger inherent in the manual inspection required to identify a particular physical building element and the specific attributes of that element as they currently exist.

It is also to be understood that aspects of the present disclosure may not necessarily address one or all of the issues noted in the Background above.

It can thus be seen that there are many aspects of the present invention, including particular additional or alternative features that will become apparent as this specification proceeds. It is therefore understood that the scope of the invention is to be determined by the claims and not by whether the claimed subject matter solves any particular problem or all of them, provide any particular features or all of them, or meet any particular objective or group of objectives set forth in the Background or Brief Summary of Some Aspects of the Disclosure.

### BRIEF DESCRIPTION OF THE DRAWINGS

The preferred and other embodiments are shown in the accompanying drawings in which:

FIG. 1 is a computer network or similar digital processing environment in which a BIM Tracking System can be implemented;

FIG. 2 is an alternate computer network or similar digital processing environment in which the BIM Tracking System can be implemented;

FIG. 3 is a block diagram of the internal structure of a computer (e.g., client processor/device 22 or server computers 30) used in the computer network of FIG. 1 and FIG. 2;

FIG. 4 is a block diagram of the BIM Tracking System services and data stores;

FIG. 5 is a block diagram of the local services, local data store and communication protocols used in the BIM Tracking System of FIG. 4;

FIG. 6 is a detailed schema for the BIM Cloud Services data store used in the BIM information tracking system of FIG. 4;

FIG. 7 is a detailed schema for the BIM Tracking Services Client data store used in the BIM information tracking system of FIG. 5;

FIG. 8 is a set of data diagrams of the structured data objects transferred between components of FIG. 4;

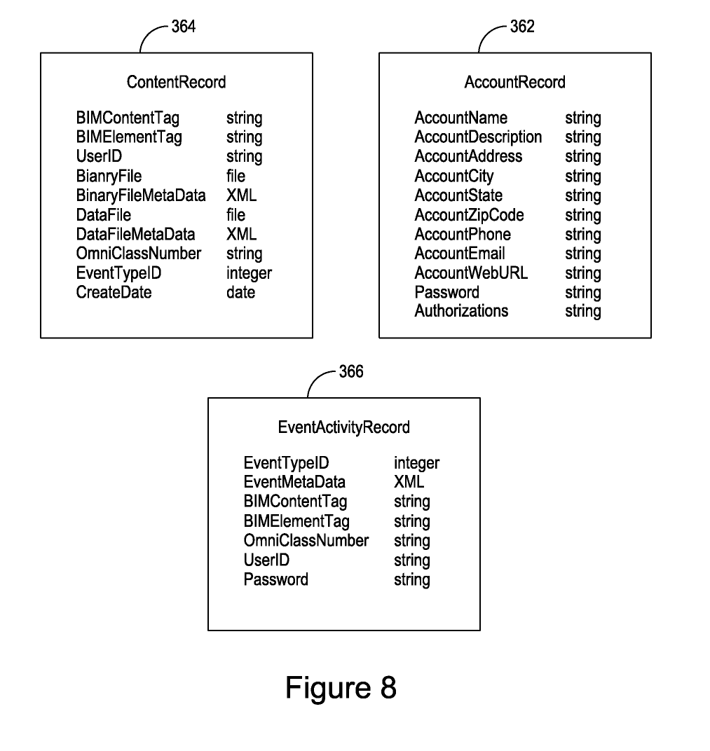

FIG. 9 is a block diagram of a Content Tracking Service in the BIM Tracking System of FIG. 4 and FIG. 5;

FIG. 10 is a block diagram of a Communication Service and supporting BIM Cloud Web Services used in the BIM Tracking System of FIG. 4 and FIG. 5;

FIG. 11 is a block diagram of an I/O Service Application API Wrapper in the BIM Tracking System of FIG. 5;

FIG. 12 is a flowchart of a process of tagging BIM content according to an exemplary embodiment disclosed herein;

FIG. 13 is a flowchart of a process of tagging all instantiated BIM content in an active model according to an exemplary embodiment disclosed herein;

FIG. 14 is a flowchart of an automated process of tagging all instantiated elements from selected BIM content in an active model according to an exemplary embodiment disclosed herein;

FIG. 15 is a flowchart of a process of tagging all BIM elements derived from selected BIM content in an active model according to an exemplary embodiment disclosed herein;

FIG. 16 is a flowchart of a process of recording BIM information data modification events according to an exemplary embodiment disclosed herein;

FIG. 17 is a flowchart of a process of recording activities relating to physically deployed building elements associated with tagged BIM elements according to an exemplary embodiment disclosed herein;

### DETAILED DESCRIPTION

The following description provides examples, and is not limiting of the scope, applicability, or configuration. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

Certain embodiments of the invention are described with reference to methods, apparatus (systems) and computer program products that can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Depending on the embodiment, certain acts, events, or functions of any of the methods described herein can be performed in a different sequence, can be added, merged, or left out all together (e.g., not all described acts or events are necessary for the practice of the method). Moreover, in certain embodiments, acts or events can be performed concurrently, e.g., through multi-threaded processing, interrupt processing, or multiple processors or processor cores, rather than sequentially. Moreover, in certain embodiments, acts or events can be performed on alternate tiers within the architecture.

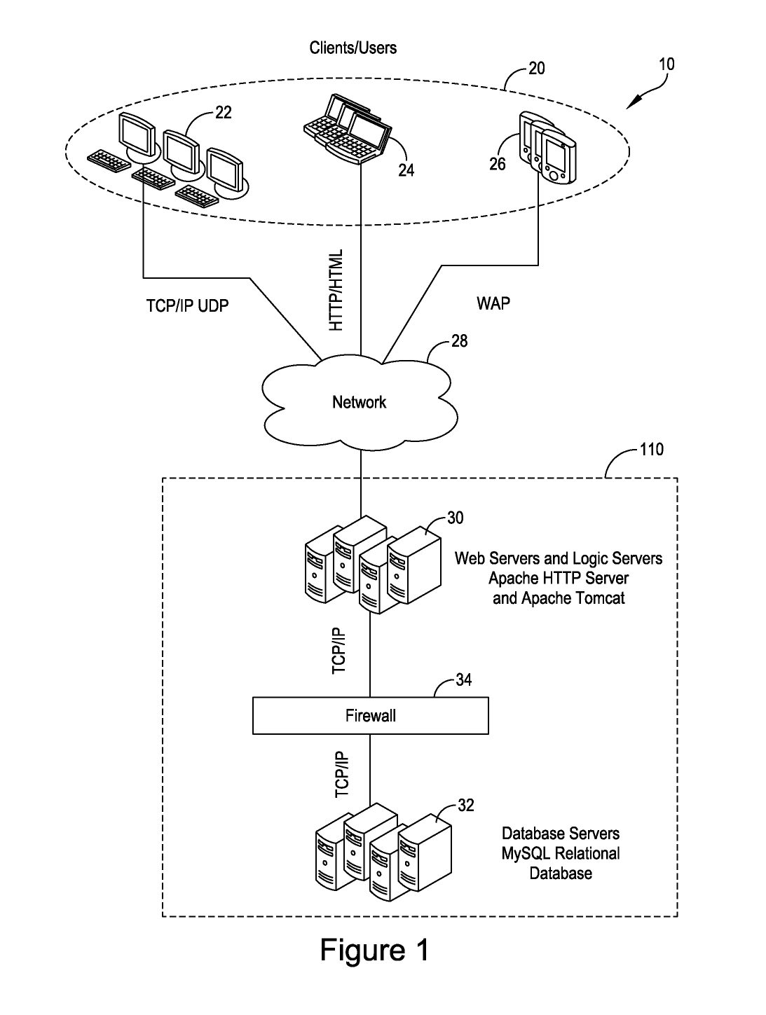

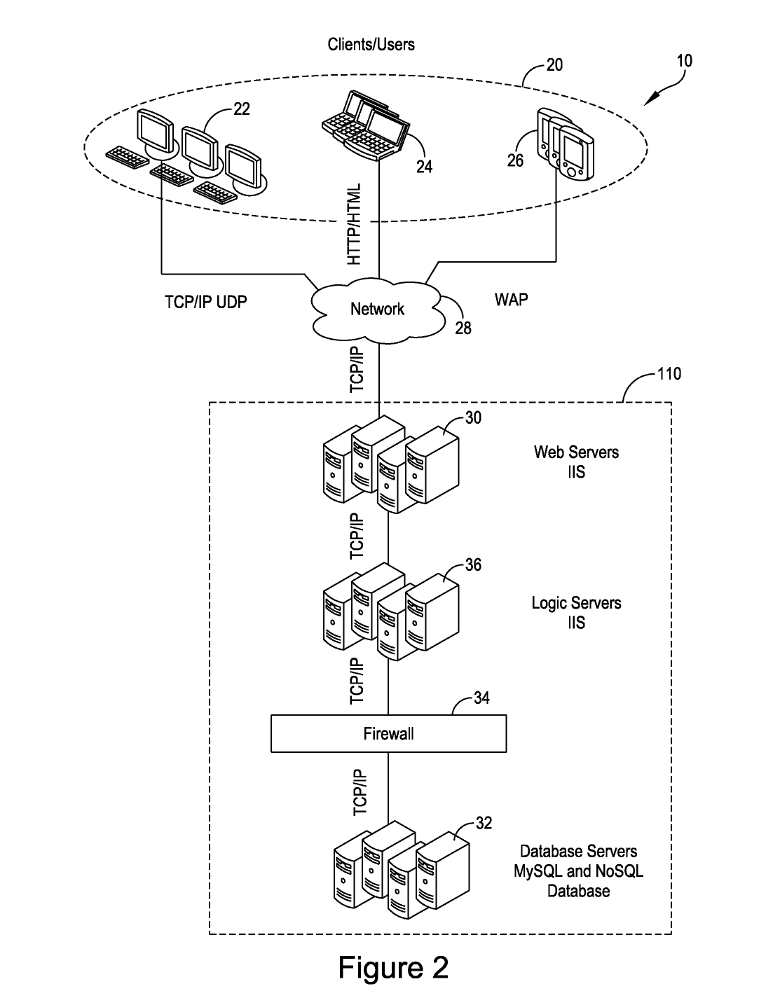

With reference to FIG. 1, a computer network or similar digital processing environment in which the system and method disclosed can be implemented. With reference to FIG. 2, an alternate architecture to accomplish the same objects can be implemented. The present systems and methods also can run on different architectures, such as LAN, WAN, Stand-alone PC, stand-alone, clustered, or networked mini or mainframe computers, etc.

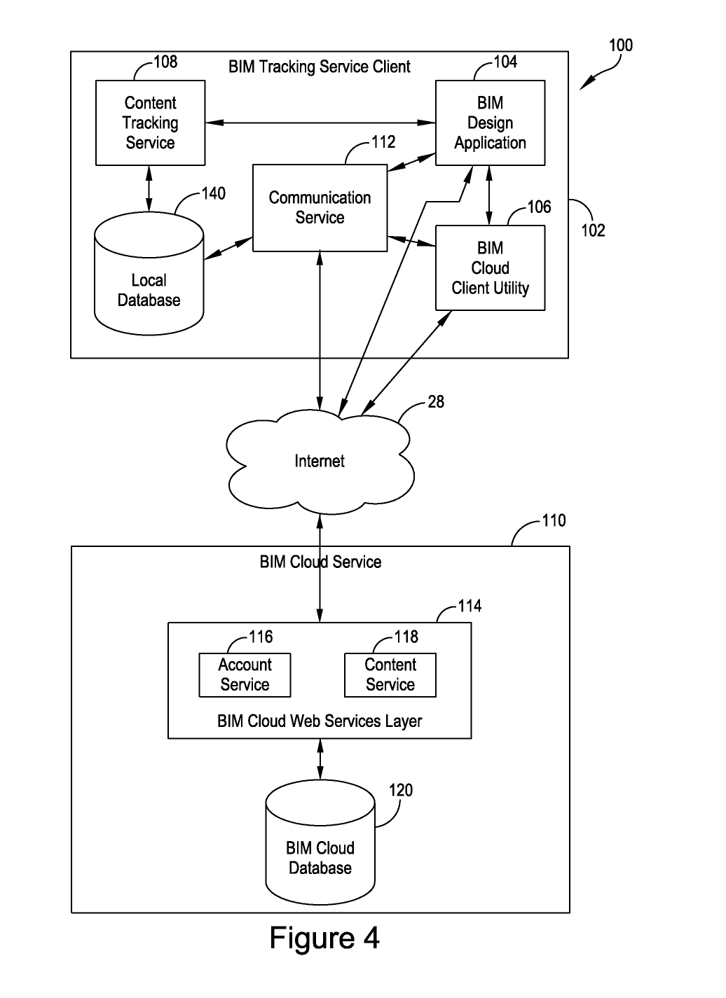

With reference to FIG. 1, the BIM Cloud Service in FIG. 4 is hosted on two primary computers 30, 32 according to an exemplary embodiment. One primary computer, the web server 30, runs Apache HTTP Server and Apache Tomcat. The other primary computer, the SQL database server 32, runs an instance of MySQL relational database. In an alternate embodiment, computers are deployed as virtual instances rather than physical computers.

A firewall system 34 is located between the web server 30 and SQL database server 32 in order to protect the database server from entities that access the web server 30 and general Internet traffic. The firewall system 34 is configured to allow only connections from the designated web server 30 and conventional administrative computing consoles (not shown).

FIG. 1 and FIG. 2 are representative of many specific computing arrangements that can support the system and method disclosed. The software implementing the BIM Cloud Service 110 can run in various software environments: Microsoft.NET, Linux/Apache, etc., in any hardware having enough power to support timely operation of the software shown in FIG. 1. The client software running on the client systems 20 may also run in various software environments, such as, for example, Microsoft Windows, Mac OS X, Linux, etc. The mobile computing device 26 can be a smart phone or smart pad device using Google Android OS, Apple iOS, RIM Blackberry OS, or any other software environment capable of supporting a Web browser or software application specifically designed to transfer information to and from the BIM Cloud Service 110. The mobile computing device 24, 26 can also be a standard PC laptop, a wearable computer, a custom handheld device, or any mobile device capable of supporting a web browser or software application specifically designed to present information to and from the BIM Cloud Service 110.

With reference now to FIG. 2, a third logic server system 36 is between the web server 30 and firewall system to communicate through the firewall 34 with the database servers 32. The logic servers 36 host web services and components as needed or desired, in order to reduce processing load on the web servers 30 and database servers 32. In order to support load balancing as network traffic demands, the web servers 30 are supplemented by yet additional web servers (not shown) arranged in a “web farm” or “cluster” configuration. The same strategy may be employed on the database server 32 side of the overall system 10 for load balancing of the database server functions. All servers 30, 32, 36 communicate with each other using the TCP/IP protocol. The servers 30, 32, 36 pass information as structured files, structured data streams such as XML, and structured data objects.

With reference to both FIG. 1 and FIG. 2, client computers of various types 20 connect to the web servers 30 and any supporting web farm web servers (not shown) via the public Internet 28 through HTTP, TCP/IP and UDP protocols. Also, mobile computing devices can connect to the web servers 30 over a wireless network via WAP.

Client computer(s)/devices 20 and server computer(s) 30, 32, 36 provide processing, storage, and input/output devices executing application programs. Client computer(s)/devices 20 can run both a BIM Design Application, for example Autodesk Revit®, and BIM cloud services client software for the BIM Tracking System 100. Client computer(s)/devices 20 can also be linked through communications network 28 to other computing devices, including other client devices/processes 20 and server computer(s) 30, 32, 36. Server computer(s) 30, 32, 36 run software to implement a BIM Cloud Service 110 which maintains the BIM Cloud Database 120 for tracking BIM content and providing related services. Communications network 28 can be part of a remote access network, a global network (e.g., the Internet), a worldwide collection of computers, local area or wide area networks, and gateways that currently use respective protocols (TCP/IP, UDP, etc.) to communicate with one another. A mobile computing device 26 provides a user interface for mobile access to the BIM Cloud Service 110 including access to information and logging of activities. The engineering workstation 22, the laptop 24, the mobile computing device 26, and the BIM Cloud Service 110 are interconnected via the communication network 28. Multiple instances of the engineering workstation and mobile computing device 20 may operate in the BIM Tracking Service 100 simultaneously.

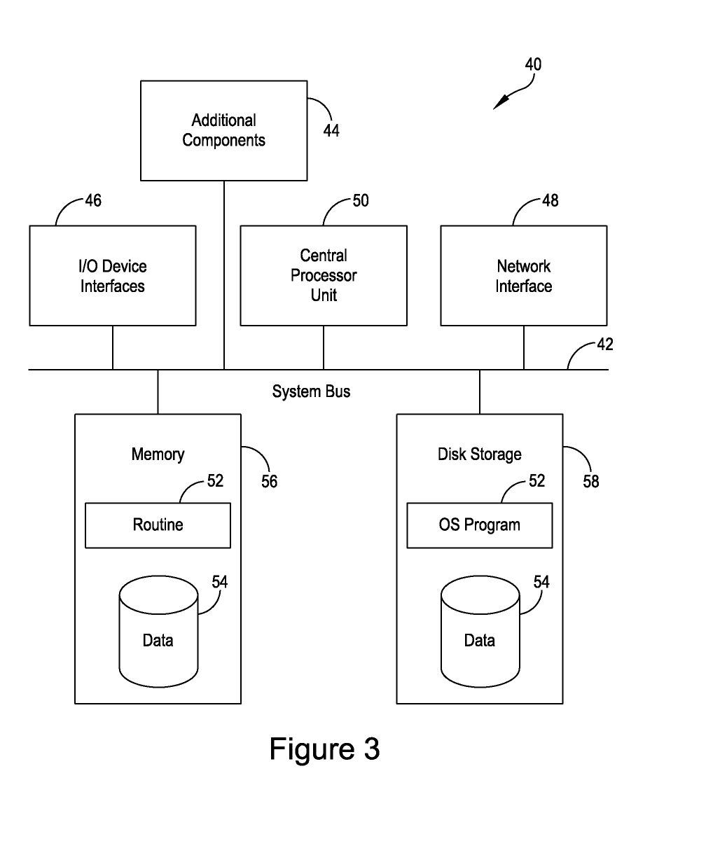

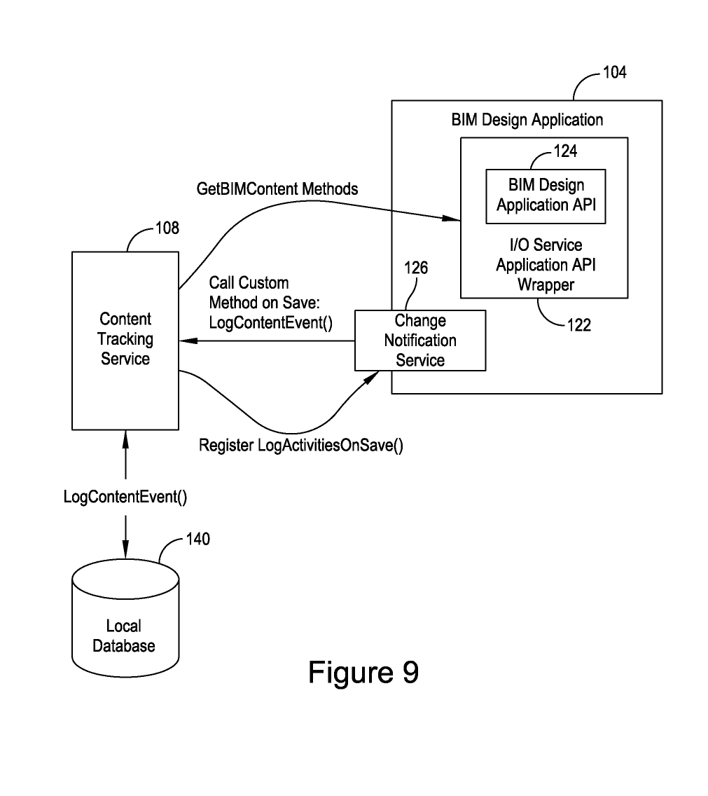

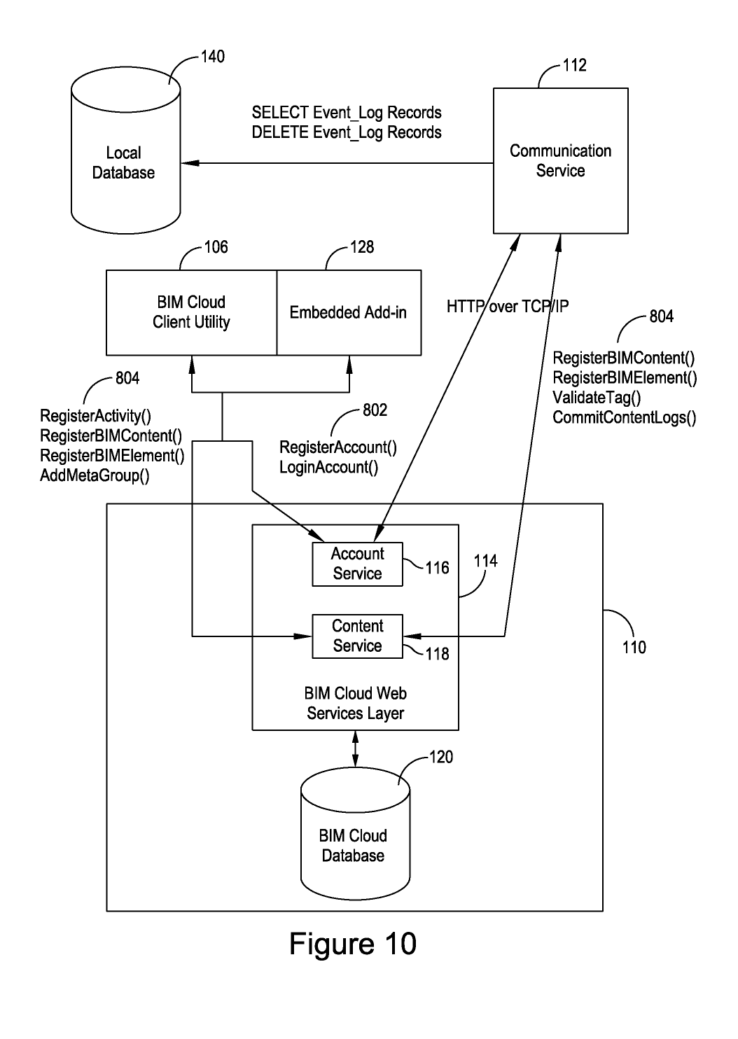

With reference to FIG. 3, each component of the system 40 is connected to system bus 42, providing a set of hardware lines used for data transfer among the components of a computer or processing system. Also connected to bus 42 are additional components 44 of the BIM Tracking System 100 such as additional memory storage, digital processors, network adapters and I/O devices. Bus 42 is essentially a shared conduit connectin different elements of a computer system (e.g., processor, disk storage, memory, input/output ports, network ports, etc.) and enabling transfer of information between the elements. I/O device interface 46 is attached to system bus 42 in order to connect various input and output devices (e.g., keyboard, mouse, displays, printers, speakers, etc.) to the BIM Tracking System 100. Network interface 48 allows the computer to connect to various other devices attached to a network (e.g., network 28 of FIG. 1). Memory 56 provides volatile storage for computer software instructions 52 and data 54 used to implement methods employed by the system disclosed herein (e.g., the LogContentEvent( )method in FIG. 9 and the RegisterAccount( )method of FIG. 10). Disk storage 58 provides non-volatile storage for computer software instructions 52 and data 54 used to implement an embodiment of method of the present disclosure. Central processor unit 50 is also attached to system bus 42 and provides for the execution of computer instructions.

In one embodiment, the processor routines 52 and data 54 are a computer program product, including a computer readable medium (e.g., a removable storage medium such as one or more DVDROM's, CD-ROM's, diskettes, tapes, etc.) that provides at least a portion of the software instructions for the system. Computer program product that combines routines 52 and data 54 may be installed by any suitable software installation procedure, as is well known in the art. In another embodiment, at least a portion of the software instructions may also be downloaded over a cable, communication and/or wireless connection.

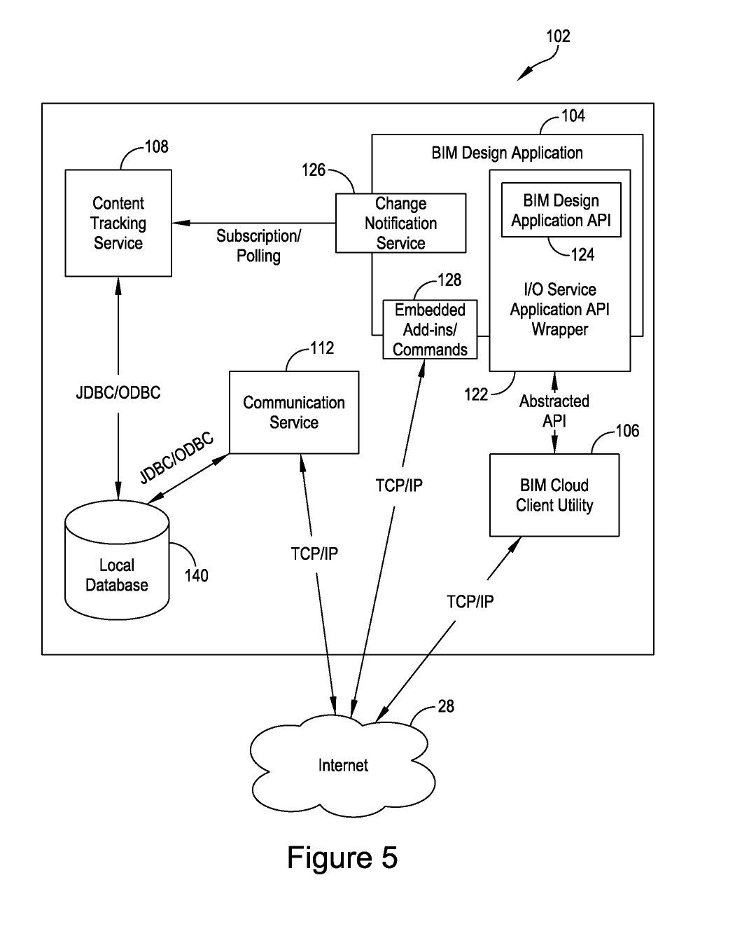

With reference now to FIG. 4 and FIG. 5, a BIM Design Application 104 (for example, Autodesk Revit™) enables a user to create a BIM model of a building or other construction. BIM Design Applications typically allow direct access to BIM models through application programming interfaces and services 124, 126. Such access typically includes: (1) access to model graphical data and model parameter data; (2) the ability to insert, modify, and delete elements and parameter data; (3) the ability to create embedded add-ins to automate repetitive tasks; and (4) the ability to subscribe to event notifications, among other operations.

The BIM Cloud Client Utility 106 provides a user interface to the functions of the BIM Cloud Service 110. Such interface may be browser-based or application-based. A Content Tracking Service 108 runs automatically without user interaction to monitor actions within the BIM Design Application 104 that involve the use of BIM content and BIM elements tracked by the BIM Tracking Service 100. A Local Database 140 comprises non-volatile data that is needed for tracking BIM content and BIM element changes, for accessing the BIM Design Application 104, and for the operation of the Content Tracking Service 108 and the Communication Service 112. This non-volatile data includes information represented in the Local Data Schema 300. The BIM Cloud Service 110 includes a BIM Cloud Web Services Layer 114 that exposes Account Services 116 and Content Services 118 for access by authorized BIM Tracking Service Clients 102. It is through these services that information is added to, and retrieved from, the BIM Cloud Database 120. The BIM Cloud database 120, together with the Local Database 140, constitute a collection of distributed databases with methods and algorithms for maintaining current tracking information about BIM content and BIM elements. The Communications Service 112, Embedded Add-ins and Commands 128, and BIM Cloud Client Utility 106 implement the local portion of these algorithms.

In an exemplary embodiment, the Local Database 140 is a relational data store accessible using standard SQL syntax over ODBC or JDBC. In an alternate embodiment, this data store can be implemented using other persistent data storage methods, such as flat files, object database or XML database, each with the appropriate interface for data updating and retrieval. In an exemplary embodiment, only the Content Tracking Service 108 and Communication Service 112 access the Local Database 140 directly.

The Communication Service 112, Embedded Add-ins and Commands 128, and BIM Cloud Client Utility 106 can communicate with the BIM Cloud Service over TCP/IP. In an exemplary embodiment, these components use JSON as a communication protocol to communicate with the BIM Cloud Web Services Layer 114 of the BIM Cloud Service 110. In another embodiment, other protocols are used such as REST and SOAP.

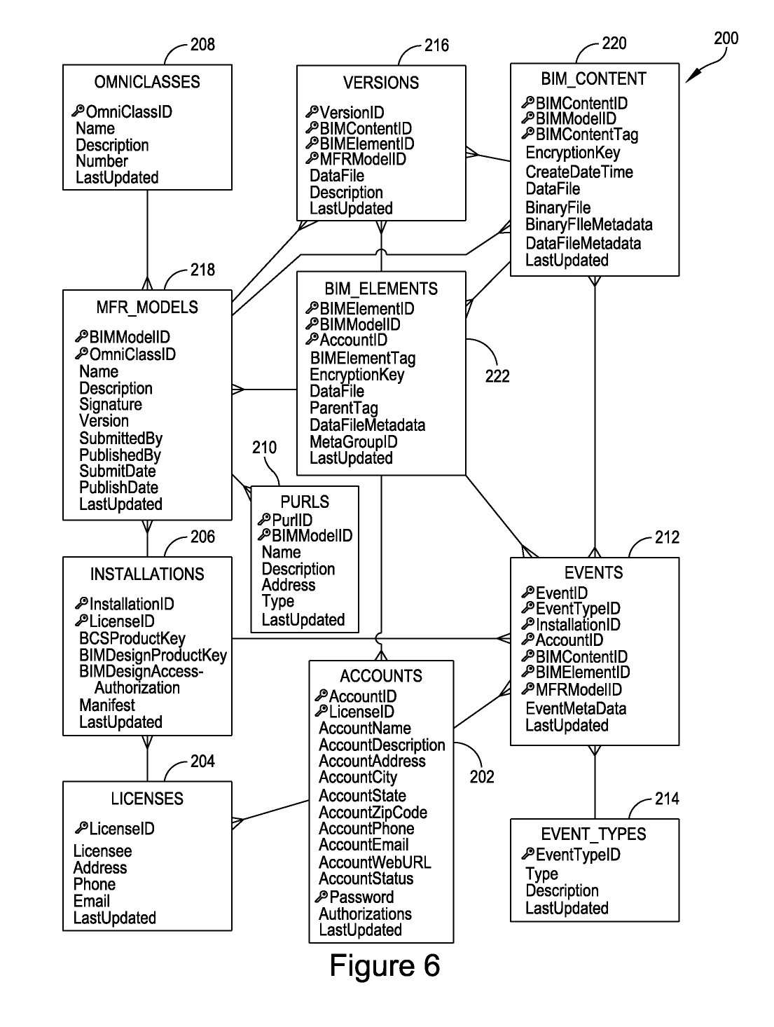

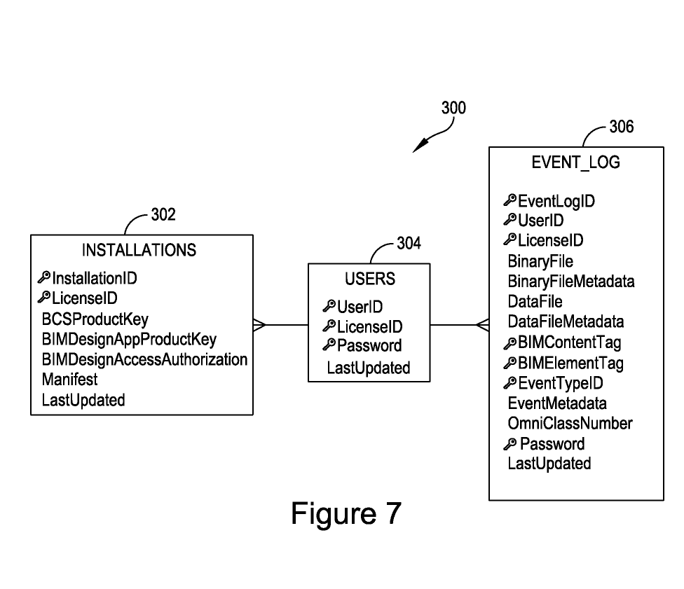

With reference to FIG. 6 and FIG. 7 a detailed schema is described for implementing the distributed database model of the BIM Information Tracking System 100 according to an exemplary embodiment. With reference to FIG. 6, the tables and relationships contained in the schema are maintained in the BIM Cloud Database 120 by the BIM Tracking Cloud Service 110 in an exemplary embodiment of the BIM Information Tracking Service 100. With reference to FIG. 7, the tables and relationships contained in the schema are maintained in the BIM Information Tracking Service Client 102 by the Content Tracking Service 108 and Communication Service 112.

With reference to FIG. 6, an ACCOUNTS table 202 contains information about every authorized user of the BIM Tracking Service. Each record in the ACCOUNTS table 202 includes values for AccountID, LicenseID, Password and LastUpdated fields. AccountID is a unique text string by which an authorized user is known to the BIM Information Tracking Service 100. In an exemplary embodiment, descriptive metadata associated with the authorized user may be included in an ACCOUNTS record and comprises such fields as AccountName, AccountDescription, AccountAddress, etc. The AccountStatus field is used to indicate whether or not the Account is active. In an exemplary embodiment, if AccountStatus is set to inactive, the account credentials cannot be used to access the BIM Cloud Web Services Layer 114 from BIM Tracking Service Clients 102. The LicenseID field identifies the entity that has obtained access to the BIM Tracking Service 100 for the authorized user by reference to the LICENSES table 204. This is typically the company or business for which the user works, but this can be an individual. The Password field is set to a value chosen by the authorized user and serves to control access to the BIM Tracking Service 100. The Authorizations field indicates which of many specific functions of the BIM Tracking Service 100 the authorized user may access. In an exemplary embodiment, this value is stored as an array of values corresponding to specific functions exposed by the BIM Cloud Web Services Layer 110.

An INSTALLATIONS table 206 contains information relevant to every authorized installation of the BIM Cloud Client Utility software 106 and the Embedded Add-ins 128 for the BIM Tracking Service system 100. The value in the BCSProductKey field activates and uniquely identifies an authorized installation. The LicenseeID field contains a value that corresponds to a unique value in the LICENSES table 204 and indicates the entity that has been licensed to install the client software for the BIM Tracking Service 100. This is typically a company or business but may be an individual. The BIMDesignProductKey field contains a value that activates and uniquely identifies an authorized installation of a BIM Design Application 104. The BIMDesignAccessAuthorization field contains information used by the Content Tracking Service 108 or the Change Notification Service 126 to access the BIM Design Application 104. This information can be retrieved from the Local Database 140 and passed directly to the BIM Design Application 104, or as appropriate, through subscription to an independent Change Notification Service 126 that may use this information to access the BIM Design Application 104. The Manifest value comprises the version numbers, dependencies, and other software environment variables associated with the client software for the BIM Tracking Service 100.

The BIM_CONTENT table 220 and BIM_ELEMENTS table 222 are the primary tables for tracking BIM information in the BIM Tracking Service 100. A BIM_CONTENT table 220 contains information about all BIM content tracked by the BIM Tracking Service 100. The BIMContentID field is the primary key (integer) that uniquely identifies the BIM_CONTENT record. The BIMModelID field is a foreign key that relates to the primary key in the MFR_MODELS table 218. The BIMContentTag field stores the tag information for the associated BIM content. The EncryptionKey field is used to encrypt and decrypt other BIM content data, including the BIMContentTag. Any binary file and data file included in a BIM content registration request is stored in the database and referenced by the BinaryFile and DataFile fields respectively. In addition, the two corresponding metadata fields store extracted metadata from the corresponding files.

A BIM_ELEMENT 222 contains information about all BIM elements tracked by the BIM Tracking Service 100. The BIMElementID field is the primary key (integer) that uniquely identifies the BIM_ELEMENT record. The BIMModelID field is a foreign key that relates to the primary key in the MFR_MODELS table 218. The AccountID field is a foreign key that relates to the primary key in the ACCOUNTS table 202, indicating the user that created the record. The BIMElementTag field stores the tag information for the associated BIM element. The EncryptionKey is used to encrypt and decrypt other BIM element data, including the BIMElementTag. Any data file included in the BIM element registration request is stored in the database and referenced by the DataFile field. The ParentTag field is the BIMContentTag value of the tag value for the BIM content from which that BIM element is derived. In addition, the DataFileMetadata field stores extracted metadata from the data file. The MetaGroupID field is used to designate any aggregates, to which, the BIM element belongs.

In an exemplary embodiment, the data file type for BIM content and BIM elements is the same. In an alternate embodiment, the data file type for BIM content and BIM elements varies. The type of file added to the BIM Cloud Database 120 will depend on the type of file obtained by the BIM Tracking Service Client 102. In an exemplary embodiment, the DataFile field contains the data file uploaded from a BIM Tracking Service Client 102 to the BIM Cloud Service 110. In an alternate embodiment, the DataFile field contains a pointer to an associated data file in a file repository external to the BIM Cloud Database 120.

A VERSIONS table 216 contains information about versions of the BIM Content data files and BIM element data files, and maintains historical revisions of data files. The VersionID field is the primary key (integer) that uniquely identifies the VERSIONS record. The BIMContentID, BIMElementID and MFRModelID fields are foreign keys that relates to the primary key in the BIM_CONTENT table 208, BIM_ELEMENT table 222, and MFR_MODELS table 218, respectively. In an exemplary embodiment, the DataFile field contains the data file uploaded from a BIM Tracking Service Client 102 during initial BIM content or BIM element registration, or as part of the tracking method for an update to tagged BIM content or BIM elements. In an alternate embodiment, the DataFile field contains a pointer to an associated data file in a file repository external to the BIM Cloud Database 120. The Description field may contain any information about the nature of the versioning activity, the data file, the BIM content, the BIM element, or any other data of interest.

An OMNICLASSES table 208 contains industry-standard classifications for BIM content based on the The OmniClass™ Construction Classification. The OmniClassID is a unique integer value used to uniquely identify each OMNICLASSES record in the BIM Cloud Database 120. The Name, Description and Number values are associated descriptive text strings that correspond to specific OmniClass™ Construction Classification items. In an exemplary embodiment, this table is populated through the manual loading of data at regular intervals. In another embodiment, this table is automatically populated and maintained by subscription to a service external to the BIM Information Tracking Service system 100.

A MFR_MODELS table 218 contains information about BIM content submitted and published by content providers. The BIMModelID value is the primary key (integer) that uniquely identifies the MFR_MODEL record. The table also contains various fields that describe the BIM content, including the name used by the content provider to identify the BIM content, as well as an associated description. The BIMModelID field and the Name field are specific to the third party providing the associated BIM content and are useful for identification of specific BIM content provided by manufacturers. The OmniClassID field is a foreign key that relates to the primary key in the OMNICLASSES table 208. This serves to provide an OmniClass™ Construction Classification to the MFR_MODEL records. The Signature field consists of a set of known attributes inherent to a specific piece or category of BIM content that can be used to identify that BIM content without a known association with the BIMModelID. The SubmittedBy and SubmitDate fields identify the user that uploaded the BIM content associated with the BIMModelID and when this upload occurred. The PublishedBy value identifies the user that published the BIM content associated with the BIMModelID, making this content available for tracking on the BIM Cloud Tracking service 100. The PublishDate identifes when this publication of the BIM content occurred. The Version value is a foreign key that relates to the primary key VersionID on the VERSIONS table 216. This enables the association of a particular record in the MFR_MODELS table 218 to the data file associated with a particular version of a piece of BIM content. This relation allows for the capability to retrieve historical BIM content information, such as the data file associated with a down revision of a BIM content item.

An EVENT_TYPES table 214 contains a catalog of event types or use in the EVENTS table 212. The Type field is a text string that identifies the event type by name and can include, but is not limited to, insert element, modify element, delete element, tag element, install element, maintenance element, replace element, submit content, publish content, delete content, new file, new version and modify omniclass. The EventTypeID value is a unique integer that uniquely identifies the event type. The Description value is a text string that stores a description of the event type.

An EVENTS table 212 contains information about events involving BIM information. These events include both data manipulation events as well as physical activities involving deployed physical building elements. For example, the EVENTS table 212 may include records indicating a delete event occurred with respect to a BIM element. In addition, this table may also include a record indicating an installation activity occurred. An EventMetaData field stores information about the event. The table includes a series of foreign keys used to categorize the type of event and relate the event to specific BIM information contained in other tables in the BIM Cloud Database 120.

A PURLS table 210 contains information about, and pointers to, data sources relating to specific models in the BIM Tracking System 100. In an exemplary embodiment, the content referenced by the Address value is stored as unstructured data in the BIM Cloud Database 120 as a binary large object and made available to BIM Information Tracking Service Clients 102 on request. In another embodiment, the information is stored in a secure file repository where the files name and location are embedded in the Address value. In another embodiment, the Address value is a pointer to a PURL redirection service that indexes and maintains a current list of corresponding external resource URLs. The BIMModelID field is a foreign key that relates to the primary key in the BIM_CONTENT table, enabling retrieval of the related data sources. Additional text fields store descriptive data about the data sources.

Referring now to FIG. 7, an INSTALLATIONS table 302 contains information relevant to the installation of the BIM Cloud Client Utility software 106 and the Embedded Add-ins 128 for the BIM Tracking Service system 100 on a particular BIM Information Tracking Service Client 102. The InstallationID field is the primary key (integer) that uniquely identifies the INSTALLATIONS record. A BCSProductKey value activates and uniquely identifies an authorized installation. In an exemplary embodiment, this value may be passed as an argument to authorize requests sent to the BIM Cloud Service 110. A LicenseID field corresponds to a unique value in the LICENSES table 204 stored in the BIM Cloud Database 120 and indicates the entity that has been licensed to install the client software for the BIM Information Tracking Service 100. This is typically a company or business but may be an individual. A BIMDesignAppProductKey field activates and uniquely identifies an authorized installation of a BIM Design Application 104. A BIMDesignAccessAuthorization field contains any information required for the Content Tracking Service 108 or the Change Notification Service 126 to access the BIM Design Application 104. This information can be retrieved and passed directly to the BIM Design Application 104, or as appropriate through subscription to an independent Change Notification Service 126 that may use this information in order to access the BIM Design Application 104. The Manifest value comprises the version numbers, dependencies, and other software environment variables associated with the client software for the BIM Information Tracking Service 100.

A USERS table 304 contains information about the authorized user of the BIM Tracking Service 100 for that BIM Tracking Service Client. Each record in the USERS table 304 includes values for the UserID, LicenseID, and Password fields. UserID is a unique text string by which an authorized user is known to the BIM Tracking Service 100. The LicenseID indicates the entity that has obtained access to the BIM Tracking Service for the authorized user by relationship to a value in the LICENSES table 204 stored in the BIM Cloud Database 120. This is typically the company or business for which the user works, but this can be an individual. The Password is set to a value chosen by the authorized user and serves to control access to the BIM Tracking Service.

An EVENT_LOG table 306 contains information relating to BIM content and BIM elements and serves as a queue for temporarily storing records to be transferred to the BIM Cloud Service. Each record in the EVENT_LOG table 306 includes values for the EventLogID, UserID, LicenseID, Password, EventTypeID, BIMContentTag and BIMElementTag fields. The populations of other fields will vary based upon the type of event and available associated content to be transferred.

Referring now to FIG. 9, the Change Notification Service 126 provides a framework to subscribe to events impacting BIM content and BIM elements. In certain embodiments, the framework is provided as service extension of a BIM Design Application 104 that notifies subscribers when events occur. In other embodiments, the Change Notification Service is an independent process that polls the BIM Design Application 104 or the BIM content to detect the result of events impacting the BIM content or BIM elements. A custom class will subscribe to the Save event of the BIM Design Application 104 and associate custom methods to be executed upon the occurrence of the event.

In an exemplary embodiment, the LogActivitiesOnSave( ) registration will direct the Change Notification Service 126 to call the custom method LogContentEvent( ) on the occurrence of a Save event. The method first interrogates the BIM content to determine if either a BIMContentTag or BIMElementTag is present. If either tag is present, the values for each field in the EVENT_LOG table 306 are marshaled, with the exception of the EventLogID, which is generated at the time the record is added to the EVENT_LOG table 306, and an EVENT_LOG record is added to the EVENT_LOG table 306. In an alternate embodiment, the Change Notification Service 126 is implemented as a polling service external to the BIM Design Application 124. The LogContentEvent( ) is still executed in the same manner as just described, but rather than being triggered by a Save event, the Change Notification Service 126 continually polls the BIM Design Application to determine if there have been any edits to the BIM information contained in the active model. When an edit is detected, the LogContentEvent( ) is executed.

With reference to FIG. 10, the Communication Service 112 monitors the EVENT_LOG table 306 in the Local Database 140 for the existence of any records generated by the Content Tracking Service 108. A record is added to this table any time an event subscribed to in the Change Notification Service 126 occurs. If the Communication Service 112 detects the existence of any records, it retrieves the records using standard SQL syntax over ODBC or JDBC and transmits them as a structured data message to the BIM Cloud Service 110 via HTTP over TCP/IP. If the BIM Cloud Service 110 returns a message indicating a successful data commit to the BIM Cloud Service database, the Communication Service 112 deletes the records from the EVENT_LOG table 306. In some embodiments, if the BIMContentTag or the BIMElementTag do not exist in the BIM Cloud Database 120, a new record will be inserted and the BIM content will be tracked.

The BIM Cloud Web Service 110 receives an EventActivityRecord 366 as a structured data message that can include a data file, a binary file, associated file information, metadata, BIMComponentTag, BIMElementTag, event type, event metadata, user identification, Omniclass number, and password. The structured data message is parsed and the extracted data is written to the appropriate tables in the BIM Cloud Database 120. Upon receiving a message from the BIM Cloud Database 120 indicating successful database commit, the BIM Cloud Service 110 responds to the Communication Service notifying it of the successful commit.

In an exemplary embodiment, the BIM Cloud Service 110 exposes an Account Web Service 116 and a Content Web Service 118. The first such service is an Account Service 116 that provides login and authentication services through the LoginAccount (string username, string password) method and RegisterAccount (Message AccountRecord 362) method 802. The LoginAccount( )method takes a username and password as arguments and validates the string pair by comparing the pair to records in the ACCOUNTS table 202 in the BIM Cloud Database 120. If a match is found, and if the AccountStatus is set to active, then a session is initiated. The RegisterAccount( ) method takes a message parameter AccountRecord 362 as its argument. The AccountRecord 362 is parsed and the extracted data is written as a new record to the ACCOUNTS table 202 in the BIM Cloud Database 120. An activation email containing an activation hyperlink is sent to the email address in the AccountRecord 362, and the AccountStatus field is set to active once the user clicks on the activation hyperlink.

The second web service exposed by the BIM Cloud Service 110 is the Content Service 118. The Content Service 118 provides content related services 804 to the Communication Service 112, the BIM Cloud Client Utility 106, and the Embedded Add-in 128. The RegisterBIMContent (Message ContentRecord 364) and RegisterBIMElement (Message ContentRecord 364) generate new tracking records in the BIM Cloud Database 120. They take a message parameter ContentRecord 364 as their argument. The ContentRecord 364 is parsed and the extracted data is written to the appropriate tables in the BIM Cloud Database 120. The CommitContentLogs (Message EventActivityRecord 366) method services the Communication Service 112 and takes the message parameter EventActivityRecord 366 as its argument. It records events and activities related to tagged BIM content and tagged BIM elements. The Content Service 118 also exposes an AddMetaGroup (string BIMElementTag) method for associating BIM elements with aggregates, as well as a ValidateTag (string BIMElementTag, string BIMContentTag) method for assessing the validity of a tag stored with a BIM element or BIM content item.

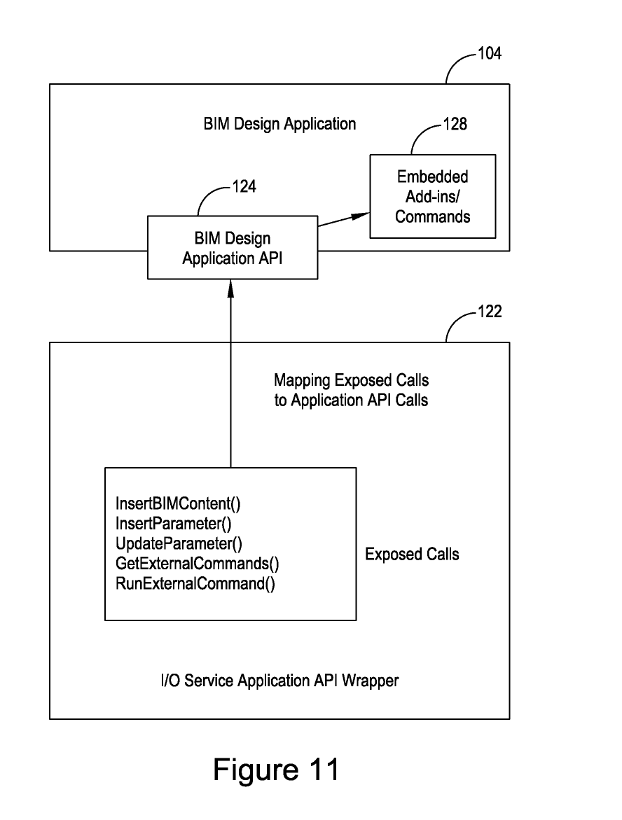

Referencing FIG. 11, an I/O Service Application API Wrapper 122 serves as a layer of abstraction to allow BIM Cloud Client Utilities 106 to access multiple BIM Design Application APIs 124 without having to modify code. For example, BIM Design Applications 104 generally provide methods to create metadata parameters in BIM models. The I/O Service Application API Wrapper 122 implements the InsertParameter( ) call. This call is then mapped internally to the appropriate BIM Design Application API 124 for the BIM Design Application 104 being accessed. Other examples of mapped calls include InsertBIMContent( ), UpdateParameter( ), GetExternalCommands( ) and RunExternalCommand( ). In an alternate embodiment, a traditional library wrapper is implemented rather than an I/O service.

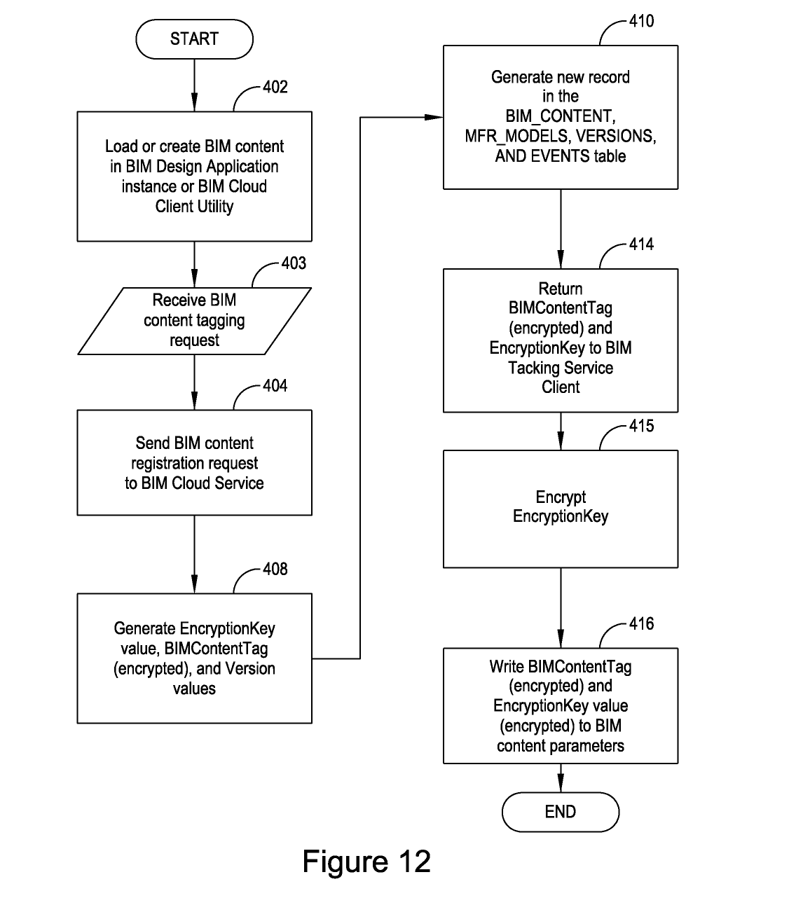

With reference to FIG. 12, a process for tagging BIM content is described. In step 402, BIM content is loaded or designed using the BIM Design Application 104 or BIM Tracking Service Client 102. In step 403, a BIM content registration request is received by the BIM Design Application 104 or BIM Cloud Client Utility 106 to tag the BIM content. In step 404, a request is sent to register the BIM content with the BIM Cloud Service 110. In an exemplary embodiment, an Embedded Add-in 128 sends this request. In another embodiment, the request is sent by the BIM Cloud Client Utility 106. The request in step 404 passes a message parameter ContentRecord 364 via the Internet 28 to the Content Service 118. In step 408, responding to the request, the Content Service 110 generates an EncryptionKey value and an encrypted BIMContentTag.

The EncryptionKey value can be any random sequence suitable for use as a two-way encryption key. For example, a 256-bit random sequence can be generated for use with two-way encryption using the 256-bit Advanced Encryption Standard (AES 256). In an exemplary embodiment, the BIMContentTag value can be formed from an instance of the well-known Globally Unique Identifier (GUID), a unique 128-bit sequence. A GUID instance is encrypted by AES 256 with the EncryptionKey to form the BIMContentTag.

In step 410, the Content Service 118 generates a MFR_MODEL record, BIM_CONTENT record, VERSIONS record, and EVENTS record using the EncryptionKey, the BIMContentTag, and the information contained in the ContentRecord 364. Any binary file and data file included in the registration request is stored in the database and referenced by the BinaryFile and DataFile fields respectively. The Content Service 118 further interrogates the binary file and data file if included and extracts available metadata for storage in the BinaryFileMetadata and DataFileMetadata fields respectively. In another embodiment, this file interrogation occurs on the BIM Tracking Service Client 102 and the extracted metadata is included in the ContentRecord 364 passed to the Content Service 118.

In step 414, the BIM Tracking Cloud Service 110 communicates with BIM Tracking Service Client 102 via the Internet 28 to indicate successful commit of the ContentRecord 364 and to return the EncryptionKey and the encrypted BIMContentTag. In step 415, the BIM Tracking Service Client encrypts the EncryptionKey. In an exemplary embodiment, the encryption process for the EncryptionKey is as follows:
a. The BIMDesignAppProductKey and the BCSProductKey are concatenated;
b. The result is hashed to generate a 256-bit value; and
c. This value is used with AES 256 to encrypt a local copy of EncryptionKey.

In step 416, the BIM Tracking Service Client 102 adds parameters to the BIM content for storing the encrypted BIMContentTag and encrypted EncryptionKey, and then writes the encrypted BIMContentTag and encrypted EncryptionKey values to the correct parameters via the BIM Design Application API 124 or the I/O Service Application API Wrapper 122. The BIM content now includes a persistent tag that can be used for tracking.

The encryption of some data ensures that only software authorized for use in the BIM Tracking Service may create, read, or change the encrypted information. Clear copies of instances of the BIM Cloud Database 120 EncryptionKey values exist only in the BIM Cloud Database 120 of the BIM Cloud Service 110. Local copies of these keys are encrypted using the BIMDesignAppProductKey and the BCSProductKey, which are different for each BIM Tracking Service Client 102. This denies the benefits of tracking and reporting on the use of BIM components to parties not authorized by the owner of the BIM Tracking Service.

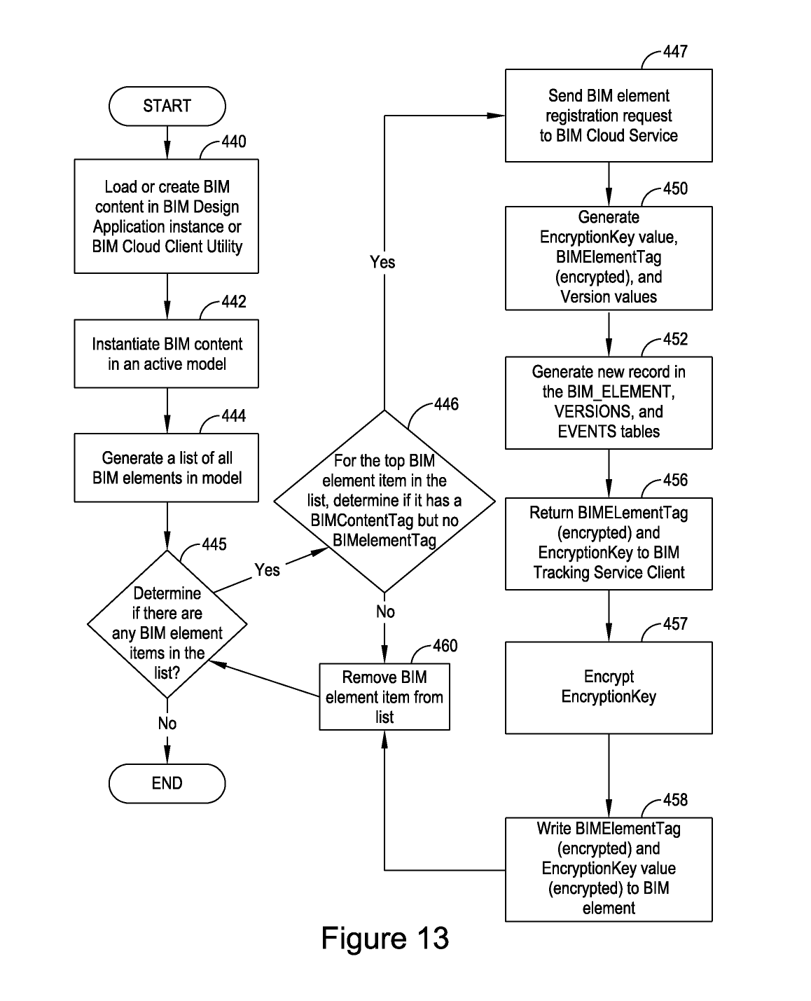

With reference to FIG. 13, in step 440, BIM content is loaded or designed using the BIM Design Application 104. In an exemplary embodiment, this BIM content is then instantiated in an active model 442. This implicitly sets the values of some parameters of the BIM content creating a BIM element. In step 444, the Change Notification Service 126 detects the occurrence of a Save event which triggers the execution of the custom interrogation method registered by the Content Tracking Service 108.

This interrogation process 445, 446 uses a list of all elements in the active model 444 and interrogates each successive element in the active model assessing whether any element contains a BIMContentTag but does not contain a BIMElementTag. In step 460, if the element contains neither a BIMContentTag nor a BIMElementTag, or if the element contains both a BIMContentTag and a BIMElementTag, it is removed from the list and no further processing occurs with respect to that element. If an element contains a BIMContentTag but does not contain a BIMElementTag, the process continues to step 447, sending a request to register the BIM element with the BIM Cloud Service 110. In an exemplary embodiment, the custom method directs the Embedded Add-in 128 to send this request. The request in step 447 passes a ContentRecord 364 via the Internet 28 to the Content Service 118. In step 450, responding to the request, the Content Service 110 generates an EncryptionKey value and an encrypted BIMContentTag as described previously.

In step 452, The Content Service 118 then generates a BIM_ELEMENT record, VERSIONS record, and EVENTS record using the EncryptionKey, the BIMContentTag, and the information contained in the ContentRecord 364. Any binary file and data file included in the registration request is stored in the database and referenced by the BinaryFile and DataFile fields respectively. The Content Service 110 further interrogates the binary file and data file if included and extracts available metadata for storage in the BinaryFileMetadata and DataFileMetadata fields respectively. In another embodiment, this file interrogation occurs on the BIM Tracking Service Client 102 and the extracted metadata is included in the ContentRecord 364 passed to the Content Service 118.

In step 456, the BIM Tracking Cloud Service 110 communicates with BIM Tracking Service Client 102 via the Internet 28 to indicate successful commit of the ContentRecord 364 and to return the EncryptionKey and encrypted BIMContentTag. In step 457, the BIM Tracking Service Client 102 encrypts the EncryptionKey as described previously.

In step 458, the BIM Tracking Service Client 102 adds parameters to the BIM content for storing the encrypted BIMContentTag and encrypted EncryptionKey, and then writes the encrypted BIMContentTag and encrypted EncryptionKey values to the correct parameters via the BIM Design Application API 124. The BIM content now includes a persistent tag that can be used for tracking purposes. In step 458, after successfully writing the encrypted EncryptionKey and encrypted BIMContentTag values to their appropriate parameters, the BIM element is removed from the list and no further processing occurs with respect to that element 460.

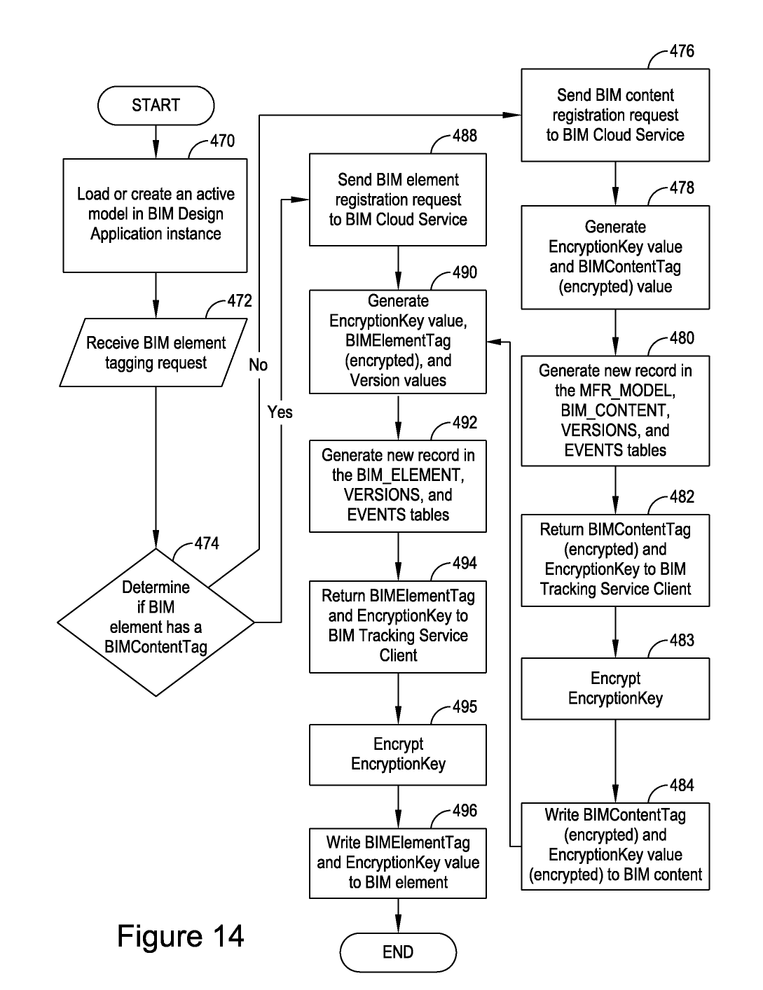

BIM elements may be tagged after they have been instantiated in a BIM model. With reference to FIG. 14, in step 470, an active model is loaded or created in the BIM Design Application 104. In step 472, a BIM element registration request is received by the BIM Design Application to tag the BIM element. In step 474, the Embedded Add-in 128 interrogates the element assessing whether it contains a BIMContentTag. If the element does not contain a BIMContentTag a request is sent 476 to register the BIM content with the BIM Cloud Service 110. In an exemplary embodiment, the Embedded Add-in 128 sends this request. The request in step 476 passes a ContentRecord 364 via the Internet 28 to the Content Service 118. In step 478, responding to the request, the Content Service 110 generates an EncryptionKey value and an encrypted BIMContentTag value.

In step 480, The Content Service 118 then generates a MFR_MODEL record, BIM_CONTENT record, VERSIONS record, and EVENTS record using the EncryptionKey, the encrypted BIMContentTag, and the information contained in the Content Record. Any binary file and data file included in the registration request is stored in the database and referenced by the BinaryFile and DataFile fields respectively. The Content Service 118 further interrogates the binary file and data file if included and extracts available metadata for storage in the BinaryFileMetadata and DataFileMetadata fields respectively.

In step 482, the BIM Tracking Cloud Service 110 communicates with Embedded Add-In 128 via the Internet 28 to indicate successful commit of the ContentRecord 364 and to return the EncryptionKey and encrypted BIMContentTag. In step 483, the BIM Tracking Service Client 102 encrypts the EncryptionKey value as previously described. In another embodiment, the Embedded Add-In 128 sends a request to the Communication Service 112, to encrypt the EncryptionKey according to the encryption process previously disclosed.

In step 484, the Embedded Add-In 128 adds parameters to the BIM content for storing the encrypted BIMContentTag and encrypted EncryptionKey, and then writes the encrypted BIMContentTag and encrypted EncryptionKey values to the correct parameters via the BIM Design Application API 124. The BIM content now includes a persistent tag that can be used for tracking purposes.

Without regard to whether the BIM element contains a BIMContentTag value, a BIMElementTag value is generated and the BIM element is tagged. In step 488 a request is sent to register the BIM element with the BIM Cloud Service 110. In an exemplary embodiment, the Embedded Add-in 128 sends this request. The request in step 488 passes a ContentRecord 364 via the Internet 28 to the Content Service 118. In step 490, responding to the request, the Content Service 110 generates an EncryptionKey value and an encrypted BIMElementTag as described previously.

In step 492, The Content Service 118 then generates a BIM_ELEMENT record, VERSIONS record, and EVENTS record using the EncryptionKey, the encrypted BIMElementTag, and the information contained in the Content Record. Any binary file and data file included in the registration request is stored in the database and referenced by the BinaryFile and DataFile fields respectively. The Content Service further interrogates the binary file and data file if included and extracts available metadata for storage in the BinaryFileMetadata and DataFileMetadata fields respectively. In another embodiment, this file interrogation occurs on the BIM Tracking Service Client 102 and the extracted metadata is included in the ContentRecord 364 passed to the Content Service 118.

In step 494, the BIM Tracking Cloud Service 110 communicates with BIM Tracking Service Client 102 via the Internet 28 to indicate successful commit of the ContentRecord 364 and to return the EncryptionKey and encrypted BIMElementTag. In step 495, the BIM Tracking Service Client 102 encrypts the EncryptionKey value as described previously. In an exemplary embodiment, the Embedded Add-In 128 sends a request to the Communication Service 112, to encrypt the EncryptionKey according to the encryption process previously disclosed.

In step 496, the BIM Tracking Service Client 102 adds parameters to the BIM element for storing the encrypted BIMElementTag and encrypted EncryptionKey, and then writes the encrypted BIMElementTag and encrypted EncryptionKey values to the correct parameters via the BIM Design Application API 124. The BIM content now includes a persistent tag that can be used for tracking purposes. In a variation of this process, an iterative loop similar to that described in FIG. 13 can be implemented supporting simplified tagging of all elements in an active model.

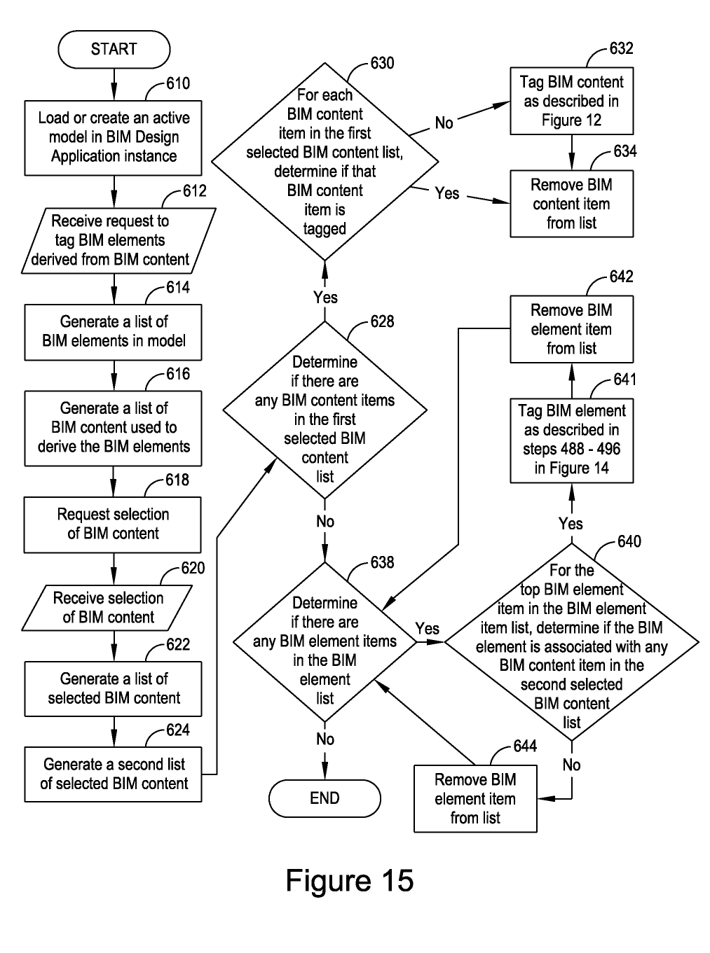

With reference to FIG. 15, in step 610, a BIM model is loaded or designed using the BIM Design Application 104. In step 612, a request is received by the Embedded Add-in 128 to tag derived BIM elements in the active model. In step 614, a list of all BIM elements in the active model is generated by the Embedded Add-in using the BIM Design Application API 124. In step 616, each BIM element item is interrogated and a list is generated of all BIM content used to derive the BIM elements in the list. In an exemplary embodiment, this is done by the Embedded Add-in using the BIM Design Application API 124. In steps 618 and 620, a set or subset of these BIM content items is identified. In steps 622 and 624, two identical lists of the selected BIM content items are generated. The duplicate BIM content item list is used to tag any untagged BIM content items in the list. In step 634, if it is determined in step 630 that an item is already tagged, no tagging operation occurs and the item is removed from the list. If that item is not tagged, the process proceeds to step 632 and the BIM Content item is tagged as described in the tagging process described in FIG. 12.

Once all selected BIM content items are tagged, the BIM element tagging process is initiated in step 628. In step 638, the list of BIM elements is assessed. If it is determined there are no items in the list, no further action is taken. If there are BIM element items in the list, these items are interrogated to determine if they were derived from a BIM content item. In step 640, the BIM content association is obtained by calling the BIM Design Application API 124 specific to that BIM Design Application 104 for returning such information. If a value is returned, it is compared to the list of BIM content items to determine if it was derived from one of the items in the list. If there is no matching item in the BIM content item list, no tagging operation occurs and the BIM element item is removed from the list 644. If there is a matching item in the BIM content item list, then in step 641, the BIM element item is tagged as described in the tagging process described in FIG. 14. In step 642, upon successful tagging, the BIM element item is removed from the BIM element item list.

In a variation of the process described in FIG. 15, the BIM Cloud Client Utility 106 may interrogate more than one particular BIM model for BIM elements derived from the list of selected BIM content. In another variation of the process described in FIG. 15, a manufacturer may define a signature, or specific information pattern, that is used by the Content Tracking Service 108 to automatically choose BIM content from that manufacturer and then proceed to automatically find and tag that BIM content and all BIM elements derived from it in one or more BIM models.

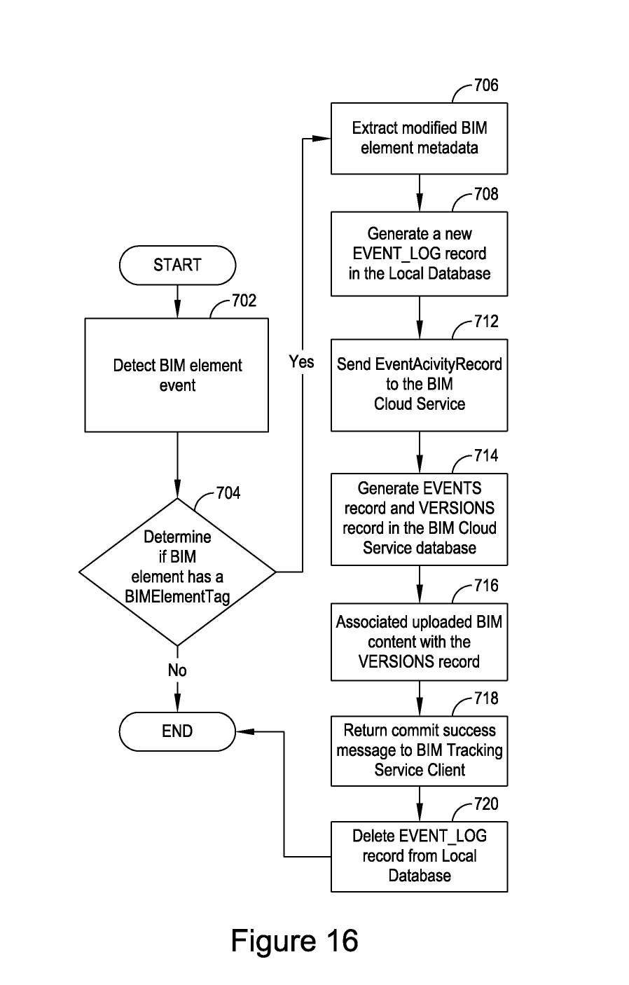

With reference to FIG. 16, in step 702, the Change Notification Service 126 detects the occurrence of a Save event which triggers the execution of the custom event logging method registered by the Content Tracking Service 108. In step 704, the custom method examines the BIM element for the presence of a BIMElementTag. According to decision step 704, if there is no tracking tag, no further action is taken, but if there is a BIMElementTag, then the process proceeds to step 706. In step 706, the BIM element data is extracted and a record is written to the EVENT_LOG table 306 in the Local Database 140. In step 712, the Communication Service 112 generates an EventActivityRecord 366 message from the values in the Local Database 140 and transfers the EventActivityRecord to the Content Service 118 via the Internet 28.

In step 714, the Content Service 118 generates an EVENTS record and a VERSIONS record using the information contained in the EventActivityRecord 366. In step 716, the data file included in the registration request is stored in the database and referenced by the VERSIONS.DataFile field. In step 718, the BIM Tracking Cloud Service 110 communicates with BIM Tracking Service Client 102 via the Internet 28 to indicate successful commit of the EventActivityRecord 366. In step 720, the Communication Service 112 deletes the EVENT record 366 in the Local Database 140.

In an alternate embodiment, the BIM Tracking Cloud Service 110 may provide a function that enables BIM content or BIM elements to be combined into more complex aggregates. The resulting aggregates are tagged and tracked as previously disclosed, but with the addition of a MetaGroupID field in the BIM_ELEMENTS table 222. For example, BIM content representing heating units may be combined with BIM content representing air conditioning units to create aggregates representing complete climate control systems for a full range of climates.

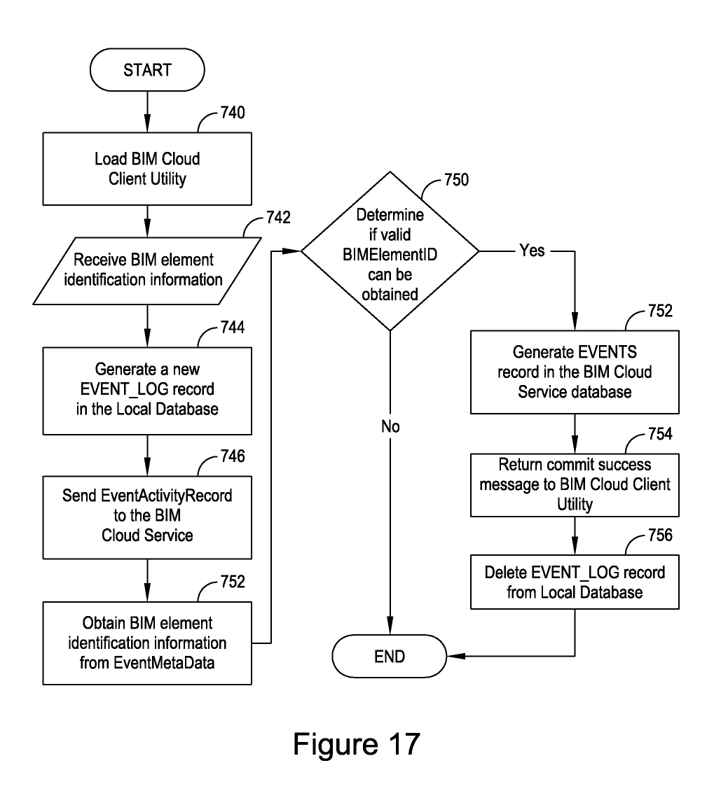

The installation, maintenance or replacement of a particular physical product represented by a BIM element in a BIM model can be an activity of interest. With reference to FIG. 17, the process for creating an EventActivityRecord 366 that records information related to the activity in the BIM Cloud Database 120 is described. In step 740, a BIM Cloud Client Utility 106 is loaded on a computing device. Examples of typical devices can include laptop computers 24 and mobile computing devices 26. In step 742, the BIM Cloud Client Utility 106 receives identification information. This identification information can include such identifiers as serial number or model number of the particular physical product. For example, a power backup system can indicate its model number and serial number by a printed label, barcode label, an RFID tag, or an embedded microprocessor. A technician can be equipped with an instance of the mobile computing device 26 capable of capturing the model number and serial number by any or all of these means. An installer can capture the model number and serial number at completion of the installation, indicating the associated BIM element either by direct reference to a view of the BIM model or by inference from the known location of the mobile computing device 26, determined by Global Positioning System or other means of determining location, and the known locations of BIM elements embedded in the BIM model.

In step 744, an EventActivityRecord 366 is generated using the current UserID, the type of activity, and the identification information received in step 742. This EventActivityRecord 366 is written to the EVENT_LOG table 306 of the Local Database 140. In step 746, the Communication Service 112 retrieves the EventActivityRecord 366 from the Local Database 140 and transfers the EventActivityRecord 366 to the Content Service 118 via the Internet 28.

In step 748, the Content Service 112 interrogates the EventMetaData value for identification information and attempts to obtain the associated BIMElementID. According to decision step 750, if no BIMElementID was obtained, no further action is taken, but if a valid BIMElementID is obtained, then the process proceeds to step 752. In step 752, the Content Service 118 generates an EVENTS record using the information contained in the EventActivityRecord 366. In step 754, the BIM Tracking Cloud Service 110 communicates with BIM Cloud Client Utility 106 via the Internet 28 to indicate successful commit of the EventActivityRecord 366. In step 756, the Communication Service 112 deletes the EVENT record in the Local Database 140.

The data collected by the BIM Tracking Service can serve as the source for the generation of a variety of useful reports. For example, a manufacturer can procure statistics of the use of each of its tagged BIM content items (representing related families of physical products) in three phases:
a. Downloads of tagged BIM content from libraries offered by the BIM Tracking Service indicate prospective use.
b. Tagged BIM elements indicate possible sales, becoming more probable as they endure.
c. Installation events for tagged BIM elements indicate completed delivery and installation.

These statistics can be analyzed and reported on by geographic location since BIM models generally have exact location information. When all major manufacturers of the same type of equipment are using the BIM Tracking Service, the use of a manufacturer's product in each of the three phases can be reported as a percentage of all equipment of the same type. For example, a manufacturer of fire detectors can procure a report for the number and percentage of its detectors in each of the three phases in each metro area of a regional sales territory.

For any BIM model built with tagged BIM content, the BIM Cloud Client Utility 106 can interrogate the BIM model via the I/O Service Application API Wrapper 122 of the BIM Design Application 104 to find tagged BIM elements derived from the tagged BIM content of a particular manufacturer. Each of these tagged BIM elements represents a specific physical product. The statistics of these product instances can be compiled to generate a detailed bill of materials for ordering from that particular manufacturer.

By compiling the statistics of installation and service events associated with tagged BIM elements, valuable reports on the installed base of associated physical products may be generated. A report that compiles the numbers of units with various lengths of time since installation enables warranty liability calculations and the planning of regularly scheduled maintenance. A report that compiles the exact locations of a particular type of unit having one in a range of specific serial numbers greatly facilitates recall or field change planning.

The following is an alphabetically sorted glossary of terms used in this patent application:

| Term | Definition |
|---|---|
| Active Model | A model loaded in an active instance of a BIM Design |
| | Application. |
| API | See “Application Programming Interface” |
| Application | An API is a source code interface that a system service |
| Programming | provides to support requests directed to the service by |
| Interface | computer programs. |
| BIM | Building Information Modeling |
| BIM Content | A class of parameterized building elements including, but |
| | not limited to, models, materials, families, family types, |
| | and other project information. |
| BIM Design | A model-based design application or service for the |
| Software | design, creation and/or modification of BIM models. |
| BIM Element | An individual intelligent object instantiated in a building |
| | model. |
| Instance | An individual occurrence of an element. |
| Intelligent | A software entity that contains relevant information about |
| Object | the geometry, connectivity, location, performance |
| | parameters, etc., of an element. |
| Load | To transfer a file or a collection of BIM Content from an |
| | outside location into a BIM Design Application project. |
| Model | A representation of a building or other design. |
| Parameter | A setting that determines the appearance or behavior |
| | of an element or type. Also called a Property. |
| Property | A setting that determines the appearance or behavior |
| | of an element or type. Also called a parameter. |
| Tagging | Associating a unique identifier with BIM content or BIM |
| | elements. |

In light of the exemplary embodiment and multiple additions and variations described above, the scope of the present invention shall be determined by the following claims.

We claim:

1. A building information tracking system comprising:
means for associating a unique identifier with BIM content or BIM elements;
means for automatically tracking and capturing user-generated building information associated with said uniquely identified BIM content and BIM elements;
a cohesive data repository for persistent storage of said captured building information;
means for transferring said captured building information to said cohesive data repository; and
means for versioning said captured building information in said data repository.
